(19) United States
(12) Patent Application Publication
(10) Pub. No.: US 2023/0366631 A1
(43) Pub. Date: Nov. 16, 2023

(54) HEAT EXCHANGER ASSEMBLY FOR A MOTOR VEHICLE

(71) Applicant: Ford Global Technologies, LLC, Dearborn, MI (US)

(72) Inventors: Tobias Duffe, Köln (DE); Morten Pyroth, Leverkusen (DE); Christian Jolk, Cologne (DE); Maximilian Klein, Düsseldorf (DE); Thomas Nitsche, Neuss (DE)

(73) Assignee: Ford Global Technologies, LLC, Dearborn, MI (US)

(21) Appl. No.: 18/315,114

(22) Filed: May 10, 2023

(30) Foreign Application Priority Data
May 10, 2022 (DE) 102022111594.1

(51) Int. Cl. F28D 1/053; F28D 21/00

(52) U.S. Cl. CPC F28D 1/05366; F28D 21/00; F28D 2021/008; F28D 2001/026

(57) ABSTRACT

A heat exchanger assembly for a motor vehicle includes a heat exchanger having at least one inlet tank, at least one outlet tank, and a plurality of exchanger tubes of an exchanger core. The exchanger tubes connect the inlet tank and the outlet tank and extend along a transverse axis that extends perpendicular to a longitudinal axis of the motor vehicle. Each exchanger tube defines a fluid passage path for fluid. A first pair of adjacent exchanger tubes form a first air passage path therebetween for ambient air and a second pair of adjacent exchanger tubes form a second air passage path therebetween for ambient air. The first air passage path has an air flow resistance that is different from an air flow resistance of the second air passage path.

### CROSS-REFERENCE TO RELATED APPLICATION

This application claims priority to and the benefit of German Patent Application No. 102022111594.1, filed on May 10, 2022. The disclosure of the above application is incorporated herein by reference.

### FIELD

The present disclosure relates to a heat exchanger assembly for a motor vehicle.

### BACKGROUND

The statements in this section merely provide background information related to the present disclosure and may not constitute prior art.

Heat exchangers are employed in motor vehicles such as cars or trucks as part of cooling circuits or refrigerant circuits which are in turn desired for cooling motor vehicle components such as the motor, gearbox, etc or for air-conditioning a vehicle interior. Some of these cooling circuits use a continuously liquid heat exchanger medium or fluid which absorbs the heat from the motor vehicle components and discharges it to the ambient air at the heat exchanger, normally a radiator installed in the front part of the motor vehicle. In other cases, the fluid enters the heat exchanger in a gaseous state, condenses in the heat exchanger, and is cooled, and leaves the heat exchanger in a liquid state. The reverse situation is also conceivable where the fluid enters the heat exchanger in a liquid state, is heated there, evaporates, and leaves the heat exchanger as a gas. The heat exchanger thus serves as an evaporator which extracts heat from the ambient air and can be used, according to the principle of a heat pump, to heat a vehicle interior.

According to a usual structure, such a heat exchanger has an inlet tank which is connected to an outlet tank by an exchanger core. The exchanger core generally consists of a plurality of spaced-apart exchanger tubes which are largely responsible for the heat exchange between the fluid and the ambient air. It could be said that the fluid is held in the inlet tank, from where it is distributed to the exchanger tubes. The fluid is conducted to the outlet tank by the exchanger tubes. The inlet tank and outlet tank can be arranged either on different sides of the exchanger core or they can be formed on the same side, possibly also as portions of a tank body which are separated from each other. In a different design, the inlet space and the outlet space are provided as separate portions in a single container. The stream of air desired for the cooling of the fluid can be conducted through the exchanger core by forced or natural convection. Heat exchange is dependent on the flow conditions of both the ambient air and the fluid inside the heat exchanger. These flow conditions can, however, be disadvantageously influenced by various factors. For example, components which are adjacent or are arranged upstream from the heat exchanger relative to the stream of air provide a non-uniform supply of air which in turn affects the heat transfer to parts of the exchanger core.

In view of the prior art described, the heat transfer properties of a heat exchanger in a motor vehicle leaves room for enhancement.

### SUMMARY

This section provides a general summary of the disclosure and is not a comprehensive disclosure of its full scope or all of its features.

It should be noted that the features and measures specified individually in the following description can be combined with one another in any desired technically meaningful way and disclose further refinements of the disclosure. The description additionally characterizes and specifies the disclosure, in particular in conjunction with the figures.

In one form, the disclosure provides a heat exchanger assembly for a motor vehicle which has a heat exchanger. The heat exchanger can also be referred to as a radiator and is generally a front radiator, i.e., a radiator or heat exchanger which is installed in the front area of the motor vehicle. In particular, the motor vehicle can be a road vehicle such as a car or truck. The heat exchanger assembly can, depending on the form, consist solely of the heat exchanger or it can have further elements which can have a functional and/or spatial relationship with the heat exchanger. Once installed, the heat exchanger is a constituent part of a heat circuit of the motor vehicle, wherein the term “heat circuit” here includes both cooling circuits, in which a continuously liquid fluid is used for the purpose of heat transport, and refrigerant circuits, in which the refrigerant is liquefied or evaporated in the heat exchanger, as in the case of a heat pump.

The heat exchanger has at least one inlet tank and at least one outlet tank for a fluid. The fluid serves for the transport of heat within the abovementioned heat circuit. The fluid inside the motor vehicle generally absorbs heat, for example from an engine of the motor vehicle, and discharges heat in the heat exchanger, wherein in the case of heat pump mode absorbing heat in the heat exchanger and discharging heat inside the motor vehicle are also possible. The fluid can be continuously liquid but can also be at least partially gaseous, wherein at least partial liquefaction or evaporation can take place in the heat exchanger. The inlet tank forms a part of the heat exchanger which is arranged upstream in the heat circuit, while the outlet tank forms a part arranged downstream, i.e., the fluid enters the heat exchanger at the inlet tank and leaves it at the outlet tank. In some heat circuits, a deflection of the flow direction can be produced by valves such that, depending on the operating mode, the “inlet tank” can be situated downstream of the “outlet tank.” In this respect, it is also possible to refer more neutrally to a “primary tank” instead of an “inlet tank” and a “secondary tank” instead of an “outlet tank”. Normally one inlet tank and one outlet tank are provided but there could also be a plurality thereof.

The inlet tank is connected to the outlet tank by a plurality of exchanger tubes of an exchanger core extending along a transverse axis and a vertical axis, each of which forms a fluid passage path, wherein in each case an air passage path, which is continuous along a longitudinal axis, for ambient air is formed between adjacent exchanger tubes. Instead of an exchanger tube, it could also be referred to as an exchanger pipe or the like. The respective exchanger tube serves to guide the fluid from an inlet tank to an outlet tank. Accordingly, it has a continuous fluid passage path from the inlet tank to the outlet tank. It can be formed by a fluid duct but it would also be conceivable that an exchanger tube has a plurality of fluid ducts separated from one another. It could, however, also be considered as a plurality of exchanger tubes which are connected to one another. The cross-section of the fluid passage path and the cross-section of the exchanger tube as a whole can be configured differently, for example circularly, elliptically, polygonal (in particular rectangularly), polygonal with rounded corners.

It should be understood that each fluid duct is connected to the inside of an inlet tank and the inside of a foreign tank, while the respective exchanger tube is connected fluid tightly to the end tanks such that no fluid can escape at the transition. The inlet tank and the outlet tank can be manufactured from metal or from plastic (e.g., reinforced plastic). The exchanger tubes are preferably manufactured from metal (e.g., aluminium or an aluminium alloy) in order to provide sufficient thermal conductivity but manufacture from other materials is also possible, for example plastic or a composite material. The exchanger tubes are part of an exchanger core which extends along the transverse axis (Y-axis) and the vertical axis (Z-axis) but it is also possible to say along a transverse plane spanned by these axes. The whole cross-section of the exchanger tube within this plane can be approximately rectangular. Normally the extent of the exchanger core along the longitudinal axis (X-axis) is substantially smaller than along the transverse axis or the vertical axis. The longitudinal axis X-axis, transverse axis Y-axis, and vertical axis Z-axis are perpendicular to one another in pairs. In principle, these terms are not to be interpreted as limiting. However, the axes usually correspond to the motor vehicle longitudinal axis, transverse axis, and vertical axis with respect to the typical installed state of the heat exchanger assembly. Each exchanger tube can run completely or partially parallel to the transverse axis or to the vertical axis.

The exchanger core is desired for the heat exchange function because it has a large surface in relation to the volume of the guided fluid. A continuous air passage path for ambient air along the longitudinal axis is formed here between adjacent exchanger tubes. The adjacent exchanger tubes thus do not directly adjoin one another, or not everywhere, and instead are spaced apart at least in some areas in such a way that the air passage path is formed between them. A plurality of air passage paths can also be formed between two exchanger tubes or an air passage path which is interrupted or divided with respect to the transverse plane. In each case, the air passage path passes through the exchanger core along the longitudinal axis. However, this does not mean that it has to be oriented parallel to the longitudinal axis and instead only that ambient air can traverse the exchanger core along the air passage path. At least one such air passage path is normally formed between each pair of adjacent exchanger tubes, although it would be possible within the scope of the disclosure that adjacent exchanger tubes adjoin one another without an air passage path therebetween (i.e., there is no gap between the adjacent exchanger tubes). While the ambient air traverses the air passage path, heat exchange between it and the surfaces of the exchanger core occurs, whereby indirect heat exchange takes place between the ambient air and the fluid.

At least the exchanger core is here manufactured additively, possibly also the whole heat exchanger. An additive manufacturing method is thus used. The method here is generally one in which, based on construction data, a component is produced from shapeless or shape-neutral materials such as powders (possibly with the addition of a binder) or liquids (which also includes temporarily molten solids), in this case therefore the exchanger core or the heat exchanger. These processes are also known under collective terms such as “rapid prototyping,” “rapid manufacturing” or “rapid tooling.”

In order to produce the metal exchanger core, a powder bed method such as selective laser sintering (SLS) or selective laser melting (SLM) can be considered, wherein a powder is applied and then selectively heated and sintered or melted by means of suitable focussed radiation. In other words, the component is built up successively from parallel layers.

In addition, methods can also be considered in which a metal is applied in liquid form and then solidified. In this way, a metal object can be built up successively, wherein the building-up can likewise be affected in layers. The metal can be supplied in the form of strands or wires and melted before it is applied locally in dots as it were. Individual drops of the metal can thus be generated and be ejected through a nozzle under pressure in the manner of a jet printer. The nozzle is directed at the desired application point at which the respective drop subsequently hardens. Such a method can be classified as liquid metal printing. In contrast to powder bed methods, complete layers of powder do not need to be applied and instead targeted application at the points which correspond to the object to be manufactured is sufficient. The respective layers can have a plane form and run horizontally (i.e., perpendicularly to the direction of gravity) but non-plane layers are also possible, as are layers which are inclined to the horizontal. An applied layer can be formed as flat (“two-dimensional”), linear (“one-dimensional”), or even dots (“zero-dimensional”).

In both powder bed methods and liquid metal printing, the layers are applied one after the other to a base, i.e., a first layer is applied directly to the base, after which the further layers are applied successively one on top of the other. The base is typically designed as a build platform or base platform which generally has a plane surface to which the first metal layer is applied.

The statement that at least the exchanger core is manufactured additively does not exclude that non-additive methods are also used for finishing it, for example, material-removing methods or separating methods. For example, the additively manufactured object can be composed as a whole, on the one hand, by a portion (exchanger core or heat exchanger) which can be used later and, on the other hand, by connecting structures or support structures which connect the usable portion to the base. These connecting structures can serve, on the one hand, to mechanically support the object during the manufacture and, on the other hand, to dissipate heat from the object into the base. After the additive manufacturing has ended, the connecting structures should be removed, for example, by machining. In addition, in the case of powder bed methods, powder which may still adhere to the object or remain in depressions after the additive manufacturing can be blown out, washed out, or for example removed mechanically.

According to the disclosure, at least one passage path is formed differently in different areas of the exchanger core depending on the area such that a flow resistance which is different depending on the area results within the passage path. This can refer to at least one fluid passage path, possibly also a plurality of fluid passage paths. Alternatively or additionally, this can also refer to at least one air passage path, possibly also a plurality of air passage paths. In other words, the passage path is formed differently depending on the area by the additive manufacturing such that a different flow resistance for the fluid and for the air results in different areas. This can mean that a single passage path is formed differently in different areas, and/or that different passage paths which are arranged in different areas are formed differently. With regard to the different design, a wide range of options are available, some of which are explained further below. In each case, by adapting the flow resistance in certain areas, it is possible to adapt both the general flow rate of the fluid and air in certain areas and the formation and intensity of turbulence. Lastly, a higher flow resistance in certain areas can provide that air and fluid flow more strongly through other areas, as a result of which the heat exchange in the said other areas can be enhanced. The exchanger core can thus be customized as desired relatively inexpensively by means of the additive manufacturing method in order to obtain a desired flow behaviour.

Because of the additive manufacturing, the exchanger tubes can also be adapted as desired, wherein in each case one-piece manufacture is possible. Thus, an exchanger tube can extend either to a certain extent in a direction from one tank to an opposite tank. It would, however, also be possible that the inlet tank and the outlet tank are arranged on the same side and the exchanger tube has as it were a U-shaped design, i.e., effects a reversal of the flow. Such a tube can be manufactured additively.

Advantageously, air-turbulence elements are arranged between adjacent exchanger tubes which are manufactured additively as a single piece with at least one exchanger tube. These air-turbulence elements can have a wide range of different shapes, for example, the shape of fins which are oriented parallel to the longitudinal axis. The shape of the fins can be varied almost as desired, for example, they can have straight surfaces, two- or three-dimensional curved surfaces, and/or integrated flared surfaces. Fins can also have one or more holes or recesses. It is, however, also possible in addition for column-like structures, which can have for example a circular, elliptical, lenticular, or polygonal, for example rectangular cross-section, to be generated by the additive manufacturing. The air-turbulence elements can also run in a different fashion with respect to the adjacent exchanger tubes. In the simplest case, the air-turbulence elements can run perpendicularly to a (local) direction in which an exchanger tube, to which they are connected as a single piece, runs. The air-turbulence elements could, however, also run at an angle other than 90°, i.e., obliquely. At least two air-turbulence elements could also cross over each other. The cross-section of the air-turbulence element can also change, for example taper and/or widen out. The individual air-turbulence element can connect two exchanger tubes, i.e., be connected to both of them. Alternatively, however, it can also depart from an exchanger tube and extend toward an adjacent exchanger tube but without contacting the latter. The respective air-turbulence element has been manufactured as a single piece with the exchanger tube during the additive manufacturing, i.e., it is connected to the latter by a material bond.

In one form, the relative arrangement and/or configuration of air-turbulence elements are different in certain areas. With regard to the relative arrangement, on the one hand, the spacing between adjacent air-turbulence elements can be varied. On the other hand, however, the three-dimensional arrangement can also be modified, for example in such a way that two adjacent air-turbulence elements can assume different relative positions with respect to the longitudinal axis, i.e., for example at the same height or offset relative to each other. The configuration of the air-turbulence elements relates to the geometrical shape and the size of the individual air-turbulence element. There are a large number of options here, for example, that fin-like air-turbulence elements are arranged in one area and column-like air-turbulence elements with a circular cross-section in another area.

According to another form, the spacings between adjacent air-turbulence elements in at least one area with a higher air resistance are less than in at least one area with a lower air resistance. In other words, the exchanger core has at least one area with a higher air resistance and at least one area with a lower air resistance, wherein the spacings between adjacent air-turbulence elements in the former area are smaller than in the latter area. By virtue of the smaller spacings, the cross-section available for the air flowing through is reduced. As a result, the stream of air tends to be reduced and additionally more pronounced turbulence is generated. The latter can positively influence the heat exchange because air which has already been heated by the contact with the exchanger core remains in the vicinity of the exchanger core for less time. An overall more pronounced temperature gradient is thus formed which intensifies the heat flow. It should be understood that the spacings between the air-turbulence elements, on the one hand, can be influenced by different numbers of air-turbulence elements being provided and, on the other hand, by the geometry and size of the individual air-turbulence element being chosen as different.

In yet another form, an extent of exchanger tubes along the longitudinal axis and a length of at least one air passage path along the longitudinal axis in at least one area with a higher air resistance is greater than in at least one area with a lower air resistance. In other words, the extent of the exchanger tubes along the longitudinal axis is not the same in all areas of the exchanger core and instead is different in certain areas. Because the exchanger tubes extend by different amounts along the longitudinal axis, the air passage path situated in between is also longer or shorter. A longer passage path means, in turn, in the case of otherwise similar geometrical conditions, that the air resistance is increased.

According to one form, at least one area with a higher air resistance is arranged aligned with a fan along the longitudinal axis. This relates of course to the properly installed state of the heat exchanger inside the motor vehicle. The fan can in particular take the form of an axial fan with an impeller which rotates about an axis of rotation which runs parallel to the longitudinal axis or possibly at a slight angle (for example, no more than 30°) to the longitudinal axis. In particular, a significant reduced pressure (or elevated pressure) which would cause a more pronounced air flow is created along the longitudinal axis in front of (or behind) the fan which can be driven for example mechanically by an internal combustion engine of the motor vehicle. This in turn would cause ambient air to flow strongly through the areas of the exchanger core which are arranged there, while the flow through areas offset thereto is less strong. Such a non-uniform air flow generally affects the function of the heat exchanger. If, however, an area with a higher air resistance is arranged aligned with the fan along the longitudinal axis, this causes a portion of the ambient air to be deflected into adjacent areas through which the flow is thus better and which can contribute more effectively to the heat exchange.

Likewise, at least one area with a higher air resistance can advantageously be arranged behind an air inlet opening along the longitudinal axis. The air inlet opening which is situated on the front side of the motor vehicle and can be arranged, for example, either below or above a bumper, is an area in which ambient air flows into the inside of the motor vehicle. In particular, if the heat exchanger is arranged relatively closely behind the air inlet opening, the flow onto the areas situated behind the air inlet opening along the longitudinal axis is intensified and in the case of a conventional heat exchanger would experience a more pronounced throughflow. In this form, it can be inhibited by the air resistance being increased there in certain areas. The stream of air is thus displaced partially into other areas such that an overall homogeneous throughflow of the heat exchanger results.

Overall, there may be no binary distinction between areas with a higher air resistance and areas with a lower resistance. Rather, different intermediate levels between a higher and a lower air resistance are conceivable, wherein the transition can take place more or less continuously or alternatively incrementally.

According to another form, at least one exchanger tube has a cross-section which changes along its extent. The basic geometry of the exchanger tube can here firstly be modified, for example, between circular, elliptical, polygonal, and/or other shapes. Alternatively or additionally, however, the proportions can also be modified, for example, in such a way that an exchanger tube has a square cross-section in one area and a cross-section which corresponds to an elongated rectangle in another area. The change in the cross-section can be used, for example, also to vary, as described, the extent of an exchanger tube along the longitudinal axis. The variation associated therewith in the length of the air passage path can thus take place not only between different pairs of adjacent exchanger tubes but also along the course of a pair of exchanger tubes. It is also possible to vary the local spacing between adjacent exchanger tubes in this way. Lastly, the fluid resistance, i.e., the flow resistance for the fluid flowing through, can also be modified. For example, it can be enlarged by narrowing the cross-section.

In one form, at least one exchanger tube has a plurality of fluid-turbulence elements which are manufactured additively as a single piece with a wall of the exchanger tube and extend inward from the wall. The relative arrangement and/or configuration of fluid-turbulence elements are different depending on the area. The fluid-turbulence elements can have different shapes, for example, the shape of fins which are oriented parallel to the direction of extent of the exchanger tube. It is, however, also possible in addition for column-like structures, which can have for example a circular, elliptical, lenticular, or polygonal, for example rectangular cross-section, to be generated. The cross-section can also change, for example taper and/or widen out, along a fluid-turbulence element. Additionally, the course of the respective fluid-turbulence element inside the exchanger tube can be chosen differently, for example parallel to the vertical axis, transverse to the vertical axis, or obliquely thereto. Two fluid-turbulence elements could also cross over each other. The individual fluid-turbulence element can extend completely through the fluid duct in the inside of the exchanger tube and, for example, connect opposite wall sections of the latter. Alternatively, however, it can also depart from a wall section of the exchanger tube and extend into the fluid duct without, however, contacting another wall section. The respective fluid-turbulence element has been manufactured in the course of the additive manufacturing as a single piece with the respective exchanger tube. The relative arrangement and/or configuration of fluid-turbulence elements are advantageously different depending on the area. With regard to the relative arrangement, on the one hand, the spacing between adjacent fluid-turbulence elements can be varied. On the other hand, however, the three-dimensional arrangement can also be modified, for example in such a way that two adjacent fluid-turbulence elements can assume different relative positions with respect to the direction of extent of the exchanger tube, i.e., for example at the same height or offset relative to each other. The configuration of the fluid-turbulence elements relates to the geometrical shape and the size of the individual fluid-turbulence element. There are again also different options here, for example that fin-like fluid-turbulence elements are arranged in one area and column-like fluid-turbulence elements with a circular cross-section in another area.

The spacings between adjacent fluid-turbulence elements in at least one area with a higher flow resistance are advantageously less than in at least one area with a lower fluid resistance. In other words, the exchanger core has at least one area with a higher fluid resistance and at least one area with a lower fluid resistance, wherein the spacings between adjacent fluid-turbulence elements in the former area are smaller than in the latter area. By virtue of the smaller spacings, the cross-section available for the fluid flowing through can be reduced if a plurality of fluid-turbulence elements are arranged next to one another transversely to the direction of extent of the respective exchanger tube. If the fluid-turbulence elements are arranged one behind the other in the direction of extent, the free path length which the fluid can cover between two fluid-turbulence elements is reduced to a certain extent by smaller spacings. In both cases, the stream of fluid tends to be reduced and additionally more pronounced turbulence is generated. The latter can again positively influence the heat exchange because fluid which has already been cooled or heated in the vicinity of the wall of the exchanger tube remains there for less time. An overall more pronounced temperature gradient is thus formed which intensifies the heat flow. It should be understood that the spacings between the fluid-turbulence elements, on the one hand, can be influenced by different numbers of fluid-turbulence elements being provided and, on the other hand, by the geometry and size of the individual fluid-turbulence element being chosen as different.

In another form, cross-sectional surfaces of fluid-turbulence elements transverse to the direction of extent of the respective exchanger tube are larger in at least one area with a higher fluid resistance than in at least one area with a lower fluid resistance. The cross-sectional surface transverse to the direction of extent corresponds to a cross-section onto which the fluid flows. The cross-sectional surface is, for example, larger when the fluid-turbulence element is guided completely through the fluid duct from one wall section to another (for example, opposite) wall section, whereas it is smaller when the fluid-turbulence element projects into the fluid duct only departing from one wall section.

In another form, the present disclosure provides a heat exchanger assembly for a motor vehicle. The heat exchanger assembly includes an inlet tank, an outlet tank, a plurality of exchanger tubes of an exchanger core, first air-turbulence elements and second air-turbulence elements. The exchanger tubes fluidly connect the inlet tank and the outlet tank and extend along a transverse axis that extends perpendicular to a longitudinal axis of the motor vehicle. Each exchanger tube of the plurality of exchanger tubes defines a fluid passage path for fluid. A first pair of adjacent exchanger tubes form a first air passage path therebetween for ambient air and a second pair of adjacent exchanger tubes form a second air passage path therebetween for the ambient air. The first air-turbulence elements extend vertically and are located between the first pair of adjacent exchanger tubes in the first air passage path. The second air-turbulence elements extend vertically and are located between the second pair of adjacent exchanger tubes in the second air passage path. Spacing between the second air-turbulence elements is greater than spacing between the first air-turbulence elements such that the first air-turbulence elements deflect a portion of the ambient air flowing therethrough toward the second air passage path.

In variations of the heat exchanger assembly of the above paragraph, which can be implemented individually or in any combination: the first air passage path is aligned with a fan along the longitudinal axis; the first air passage path is arranged behind an air inlet opening of the motor vehicle along the longitudinal axis; at least one exchanger tube of the plurality of exchanger tubes has a cross-section which changes along its length; the first pair of adjacent exchanger tubes extends along the longitudinal axis a greater distance than the second pair of adjacent exchanger tubes; at least one exchanger tube of the plurality of exchanger tubes has first fluid-turbulence elements and second fluid-turbulence elements disposed therein, an arrangement of the first fluid-turbulence elements is different than an arrangement of the second fluid-turbulence elements; the arrangement of the first fluid-turbulence elements includes spacing between adjacent first fluid-turbulence elements and the arrangement of the second fluid-turbulence elements includes spacing between adjacent second fluid-turbulence elements, the spacing between the adjacent second fluid-turbulence elements is greater than the spacing between the adjacent first fluid-turbulence elements;

In yet another form, the present disclosure provides a heat exchanger assembly for a motor vehicle. The heat exchanger assembly includes an inlet tank, an outlet tank, a plurality of exchanger tubes of an exchanger core, first air-turbulence elements and second air-turbulence elements. The exchanger tubes fluidly connect the inlet tank and the outlet tank and extend along a transverse axis that extends perpendicular to a longitudinal axis of the motor vehicle. Each exchanger tube of the plurality of exchanger tubes defines a fluid passage path for fluid. A first pair of adjacent exchanger tubes form a first air passage path therebetween for ambient air and a second pair of adjacent exchanger tubes form a second air passage path therebetween for the ambient air. The first air-turbulence elements extend vertically and are located between the first pair of adjacent exchanger tubes in the first air passage path. The second air-turbulence elements extend vertically and are located between the second pair of adjacent exchanger tubes in the second air passage path. Spacing between the second air-turbulence elements is greater than spacing between the first air-turbulence elements such that the first air-turbulence elements deflect a portion of the ambient air flowing therethrough toward the second air passage path. The first pair of adjacent exchanger tubes extends along the longitudinal axis a greater distance than the second pair of adjacent exchanger tubes. At least one exchanger tube of the plurality of exchanger tubes has first fluid-turbulence elements and second fluid-turbulence elements disposed therein. Spacing between the first fluid-turbulence elements is different than spacing between the second fluid-turbulence elements.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a schematic cross-sectional view of a first form of a heat exchanger assembly according to the principles of the present disclosure;

FIG. 1B is a schematic front view of the heat exchanger assembly of FIG. 1A;

FIG. 2 is a schematic cross-sectional view of a second form of a heat exchanger assembly according to the principles of the present disclosure;

FIG. 3A is a schematic cross-sectional view of a third form of a heat exchanger assembly according to the principles of the present disclosure;

FIG. 3B is a schematic front view of the heat exchanger assembly of FIG. 3A;

FIG. 4 is a schematic front view of a fourth form of a heat exchanger assembly according to the principles of the present disclosure;

FIGS. 5-10 are plan views of different forms of part of a heat exchanger assembly according to the principles of the present disclosure;

FIG. 11 is a perspective view of exchanger tubes of a fifth form of a heat exchanger assembly according to the principles of the present disclosure; and

FIG. 12 is a cross-sectional view of exchanger tubes of a sixth form of a heat exchanger assembly according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the different figures, identical parts are always provided with the same reference signs, for which reason these parts are generally also described only once.

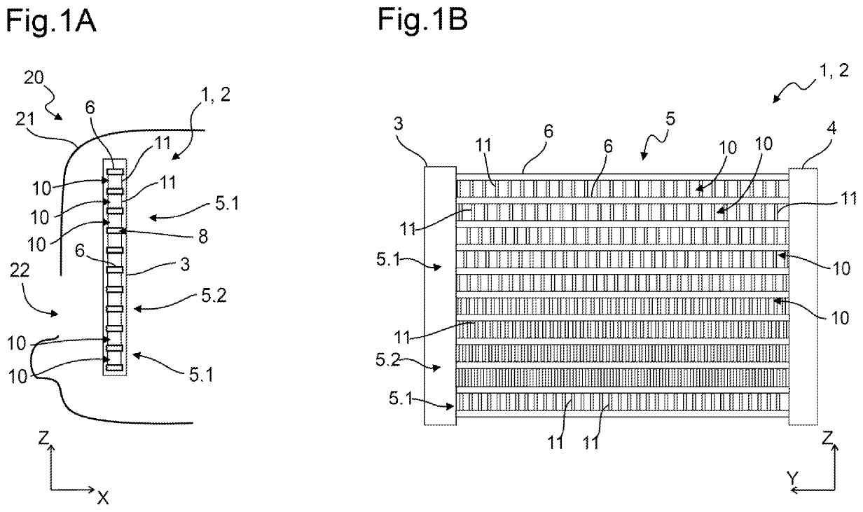

FIGS. 1A and 1B show a motor vehicle 20, in this case a car, with a first form of a heat exchanger assembly 1 according to the disclosure which has a heat exchanger 2. The heat exchanger 2 is arranged mainly behind a front panel 21 of the motor vehicle 20 along a longitudinal axis X, wherein, however, the front panel 21 has an air inlet opening 22 (FIG. 1A). The heat exchanger 2 has an inlet tank 3 (FIG. 1B) and an outlet tank 4 (FIG. 1B) for a fluid (not illustrated here), for example a coolant of the motor vehicle 20. The inlet tank 3 and outlet tank 4 extend along a vertical axis Z and are connected to each other by exchanger tubes 6 of an exchanger core 5. Each of the exchanger tubes 6 has a hollow configuration and has a fluid passage path 8 for guiding the fluid. All of the exchanger tubes 6 have a similar cross-section which in this case is rectangular and extends along the longitudinal axis X. Alternatively, it could, however, also be configured as square, circular, elliptical, or otherwise. In the example illustrated, the exchanger tubes 6 extend parallel to a transverse axis Y and each have the same spacings with respect to the vertical axis Z. An air passage path 10, through which ambient air can pass in order to exchange heat with the fluid, is defined in each case between adjacent exchanger tubes 6. In order, on the one hand, to enlarge the surface of the exchanger core 5 and, on the other hand, to influence the flow behaviour of the air, air-turbulence elements 11 which here extend parallel to the vertical axis Z are in each case arranged between adjacent exchanger tubes 6. The heat exchanger 2 is manufactured from an aluminium alloy by an additive manufacturing method, for example by a powder bed method such as SLM or by liquid metal printing. The additive manufacturing method allows efficient manufacture even of complex three-dimensional structures.

The spacings between the air-turbulence elements 11 are not constant inside the exchanger core 5. Rather, it is possible to broadly distinguish two areas or sections 5.1 with a lower air resistance and an area or section 5.2 with a higher air resistance. In the areas 5.1 with a lower air resistance, the air-turbulence elements 11 have larger spacings than in the area 5.2 with a larger air resistance. Because the latter is arranged behind the air inlet opening 22 along the longitudinal axis X, air flows primarily onto this area 5.2. Because this area 5.2 has a higher air resistance, a portion of the air is displaced or deflected into other areas 5.1 such that the flow through the latter is better as a whole and the entire exchanger core 5 can participate effectively in the heat exchange.

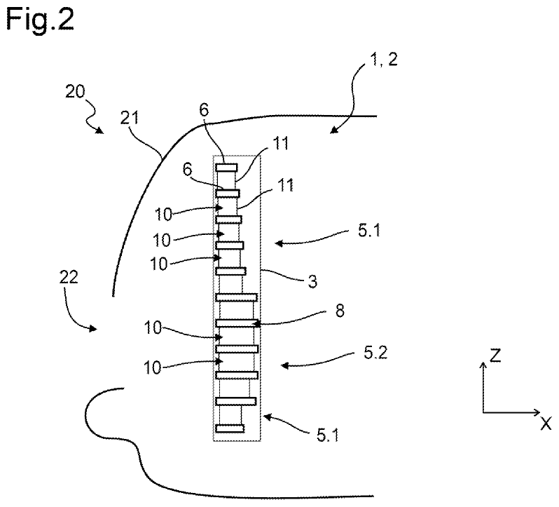

FIG. 2 shows a second form of a heat exchanger assembly 1 according to the disclosure inside a motor vehicle 20 which largely corresponds to the first form and to this extent is not explained again. In contrast to the first form, the exchanger tubes 6 in this case have different cross-sections. That is, the exchanger tubes 6 in the section 5.2 with a higher air resistance are formed so that they are longer along the longitudinal axis X than in the sections 5.1 with a lower air resistance. Accordingly, the air passage paths 10, formed between exchanger tubes 6, in the section 5.2 with a higher air resistance are also longer, which increases the air friction and moreover causes more pronounced turbulence. In this example, the air-turbulence elements 11 are also lengthened along the longitudinal axis X so that they coincide to a certain extent with the exchanger tubes 6. The spacings of the air-turbulence elements 11 can in this example be the same in all areas 5.1, 5.2 of the exchanger core 5 but they can also be different in certain areas as in the first form.

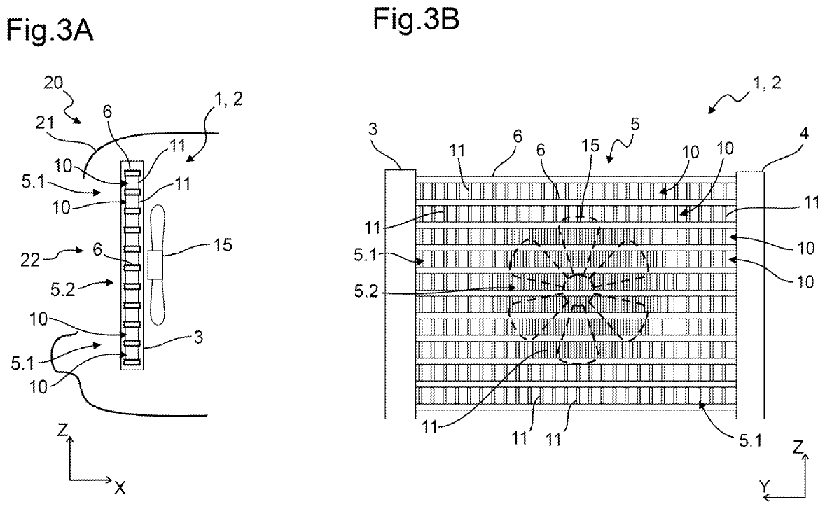

FIGS. 3A and 3B show a third form of a heat exchanger assembly 1 according to the disclosure in which a fan 15 is arranged behind the heat exchanger 2 along the longitudinal axis X. The air inlet opening 22 is here large enough such that there can be a sufficient flow onto the entire exchanger core 5. The central area 5.2 has a higher air resistance (i.e., achieved by reducing the spacings between the air-turbulence elements 11), thereby inhibiting the central area 5.2 of the exchanger core 5 from experiencing a greater air flow than areas 5.1 due to the suction effect of the fan 15. Alternatively or additionally, there would also be the possibility here of lengthening the air passage paths 10 in certain areas.

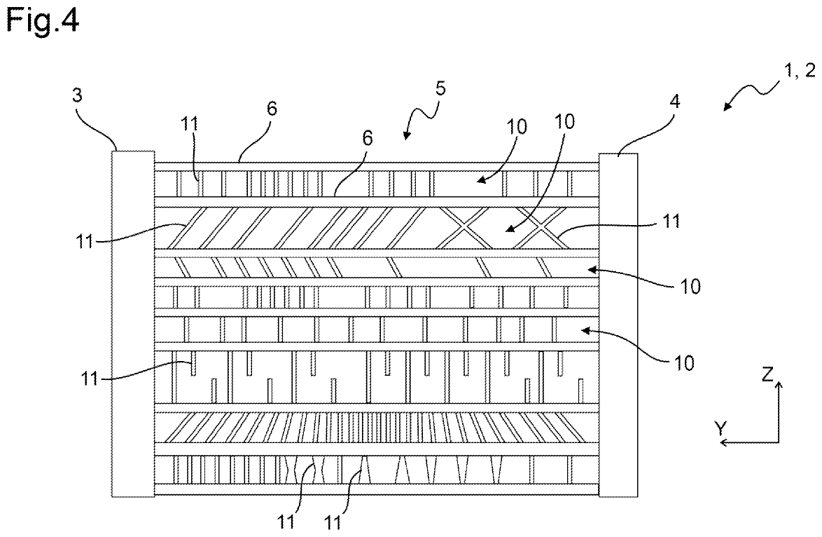

FIG. 4 shows a fourth form of a heat exchanger assembly 1 according to the disclosure or a heat exchanger 2 representing different possible options provided according to the disclosure for varying the air passage paths 10. As already stated, the spacings between the air-turbulence elements 11 can be varied. Furthermore, the orientation of the air-turbulence elements 11 relative to the exchanger tubes 6 can be modified such that they can be oriented either perpendicularly to the direction in which they run (and hence parallel to the vertical axis Z) or alternatively obliquely to the direction in which they run (and hence obliquely to the vertical axis Z). Moreover, air-turbulence elements 11 between the adjacent exchanger tubes 6 can taper or widen out and/or they can cross over each other. It is also possible that individual air-turbulence elements 11 are not formed continuously from one exchanger tube 6 to the next and instead extend only partially in the direction of the adjacent exchanger tube 6. In addition, it is also possible to vary the spacings between adjacent exchanger tubes 6, wherein a larger spacing results in a smaller air resistance than a small spacing.

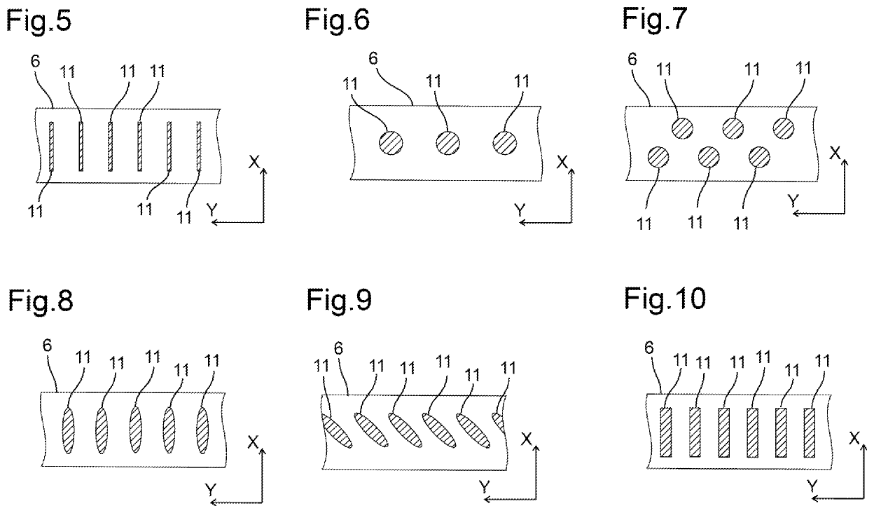

FIGS. 5-10 each show by way of example a single exchanger tube 6 with different forms of air-turbulence elements 11. In the form according to FIG. 5, the air-turbulence elements 11 are configured as fins and oriented parallel to the longitudinal axis X. FIGS. 6 and 7 each show column-like air-turbulence elements 11 with a circular cross-section, wherein only one row of air-turbulence elements 11 is provided in FIG. 6 while in FIG. 7 two rows are arranged offset to each other both with respect to the longitudinal axis X and with respect to the transverse axis Y. The form according to FIG. 7 also results in smaller spacings between the air-turbulence elements 11 and normally corresponds to a higher air resistance than the form according to FIG. 6.

FIGS. 8 and 9 show column-like air-turbulence elements 11 with an elliptical cross-section, wherein the semi-major axis of the ellipse is oriented parallel to the longitudinal axis X in FIG. 8 while it is inclined by approximately 45° with respect to the longitudinal axis X and the transverse axis Y in FIG. 9. FIG. 10 shows column-like air-turbulence elements 11 with a rectangular cross-section. While the number of air-turbulence elements 11 corresponds to that in FIG. 5, because of the greater width along the transverse axis Y, the spacings between the air-turbulence elements 11 are smaller such that a larger air resistance results.

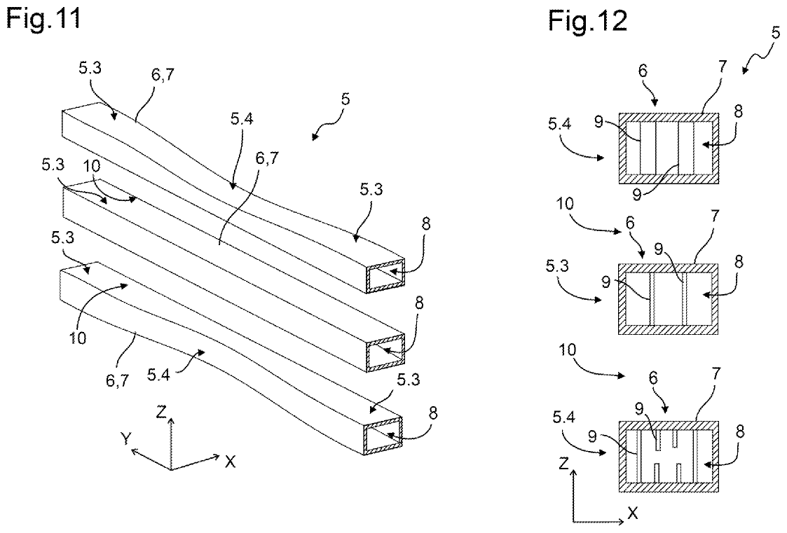

FIG. 11 shows part of an exchanger core 5 of a fifth form of a heat exchanger assembly 1 according to the present disclosure, wherein for the sake of clarity the air-turbulence elements 11 have been omitted here. Shown here by way of example are three exchanger tubes 6 which each have a wall 7 with a rectangular cross-section in which a fluid passage path 8 is again formed. The latter is, however, modified by the cross-section not being continuously constant. In the case of the exchanger tube 6 which is uppermost with respect to FIG. 11, the extent along the vertical axis Z is reduced in certain sections such that lateral areas 5.3 with a smaller fluid resistance and a central area 5.4 with a larger fluid resistance result. In the case of the exchanger tube 6 which is lowermost with respect to FIG. 11, however, although the extent along the vertical axis Z is constant, here too a central area 5.4 with an increased fluid resistance is provided because the extent of the exchanger tube 6 along the longitudinal axis X reduces there. It should be noted that the reduction in the extent along the vertical axis Z also results in a local enlargement of the air passage path 10. Likewise, the reduction in the extent along the longitudinal axis X can result in a shortening of the air passage path 10 and hence in a reduction in the air friction.

FIG. 12 shows part of an exchanger core of a sixth form of a heat exchanger assembly 1 according to the present disclosure, wherein again three exchanger tubes 6 are illustrated in a cross-sectional view. A plurality of fluid-turbulence elements 9, which have been manufactured as a single piece with the wall 7 during the additive manufacturing, are in each case connected to the wall 7 of the respective exchanger tube 6. The uppermost and the central exchanger tube 6 here in each case have two fluid-turbulence elements 9 arranged offset along the longitudinal axis X, while the lowermost exchanger tube 6 has a total of six fluid-turbulence elements 9. In the case of the two upper exchanger tubes 6, the fluid-turbulence elements 9 each pass from one section of the wall 7 to the opposite section. In the case of the uppermost exchanger tube 6, however, the cross-sectional surface of the fluid-turbulence elements 9 is enlarged (i.e., has a greater thickness) compared with the central exchanger tube 6 such that the uppermost exchanger tube 6 corresponds to a section 5.4 with a larger fluid resistance, while the central exchanger tube 6 corresponds to a section 5.3 with a smaller fluid resistance. In the case of the lowermost exchanger tube 6, the spacings of the fluid-turbulence elements 9 are less than in the case of the upper two exchanger tubes 6, as a result of which here too overall a section 5.4 with a larger fluid resistance results and the fluid resistance is modified here by some fluid-turbulence elements 9 not extending continuously from one section of the wall 7 to the opposite section and instead are formed as it were in the manner of stumps such that a free area remains in the center of the fluid passage path 8.

With regard to the cross-section of the fluid-turbulence elements 9, a wide range of different options are provided. For example, they can, as illustrated in FIGS. 5-10 for the air-turbulence elements 11, be formed in the manner of fins or columns with a rectangular, circular, or elliptical cross-section.

Although a variation in the air resistance or a variation in the fluid resistance are in each case illustrated as alternatives in the exemplary form shown here, it should be clear that these possible variations can also be combined in a heat exchanger 2.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A heat exchanger assembly for a motor vehicle, the heat exchanger assembly comprising:
a heat exchanger including at least one inlet tank, at least one outlet tank, and a plurality of exchanger tubes of an exchanger core connecting the at least one inlet tank and the at least one outlet tank and extending along a transverse axis that extends perpendicular to a longitudinal axis, each exchanger tube of the plurality of exchanger tubes defines a fluid passage path for fluid, wherein a first pair of adjacent exchanger tubes form a first air passage path therebetween for ambient air and a second pair of adjacent exchanger tubes form a second air passage path therebetween for ambient air, the first air passage path and the second air passage path being continuous along the longitudinal axis,
wherein the first air passage path has an air flow resistance that is greater than an air flow resistance of the second air passage path.

2. The heat exchanger assembly according to claim 1, wherein first air-turbulence elements are located between the first pair of adjacent exchanger tubes and second air-turbulence elements are located between the second pair of adjacent exchanger tubes, and wherein an arrangement of the first air-turbulence elements between the first pair of adjacent exchanger tubes is different than an arrangement of the second air-turbulence elements between the second pair of adjacent exchanger tubes.

3. The heat exchanger assembly according to claim 2, wherein the arrangement of the first air-turbulence elements comprises spacing between adjacent first air-turbulence elements and the arrangement of the second air-turbulence elements comprises spacing between adjacent second air-turbulence elements, and wherein the spacing between the adjacent second air-turbulence elements is greater than the spacing between the adjacent first air-turbulence elements.

4. The heat exchanger assembly according to claim 1, wherein the first pair of adjacent exchanger tubes extends along the longitudinal axis a greater distance than the second pair of adjacent exchanger tubes.

5. The heat exchanger assembly according to claim 1, wherein the first air passage path is aligned with a fan along the longitudinal axis.

6. The heat exchanger assembly according to claim 1, wherein the first air passage path is arranged behind an air inlet opening of the motor vehicle along the longitudinal axis.

7. The heat exchanger assembly according to claim 1, wherein at least one exchanger tube of the plurality of exchanger tubes has a cross-section which changes along its length.

8. The heat exchanger assembly according to claim 1, wherein at least one exchanger tube of the plurality of exchanger tubes has first fluid-turbulence elements and second fluid-turbulence elements disposed therein, and wherein an arrangement of the first fluid-turbulence elements is different than an arrangement of the second fluid-turbulence elements.

9. The heat exchanger assembly according to claim 8, wherein the arrangement of the first fluid-turbulence elements comprises spacing between adjacent first fluid-turbulence elements and the arrangement of the second fluid-turbulence elements comprises spacing between adjacent second fluid-turbulence elements, and wherein the spacing between the adjacent second fluid-turbulence elements is greater than the spacing between the adjacent first fluid-turbulence elements.

10. The heat exchanger assembly according to claim 8, wherein a thickness of the first fluid-turbulence elements is greater than a thickness of the second fluid-turbulence elements.

11. The heat exchanger assembly according to claim 1, wherein the first air passage path is located near a lower end of the heat exchanger and the second air passage path is located near an upper end of the heat exchanger.

12. The heat exchanger assembly according to claim 1, wherein the first air passage path is located adjacent the second air passage path.

13. A heat exchanger assembly for a motor vehicle, the heat exchanger assembly comprising:
an inlet tank;
an outlet tank;
a plurality of exchanger tubes of an exchanger core fluidly connecting the inlet tank and the outlet tank and extending along a transverse axis, each exchanger tube of the plurality of exchanger tubes defines a fluid passage path for fluid, a first pair of adjacent exchanger tubes form a first air passage path therebetween for ambient air and a second pair of adjacent exchanger tubes form a second air passage path therebetween for the ambient air;
first air-turbulence elements extending vertically and located between the first pair of adjacent exchanger tubes in the first air passage path; and
second air-turbulence elements extending vertically and located between the second pair of adjacent exchanger tubes in the second air passage path,
wherein spacing between the second air-turbulence elements is greater than spacing between the first air-turbulence elements such that the first air-turbulence elements deflect a portion of the ambient air flowing therethrough toward the second air passage path.

14. The heat exchanger assembly according to claim 13, wherein the first air passage path is aligned with a fan along a longitudinal axis that is perpendicular to the transverse axis.

15. The heat exchanger assembly according to claim 13, wherein the first air passage path is arranged behind an air inlet opening of the motor vehicle along a longitudinal axis of the motor vehicle, the longitudinal axis being perpendicular to the transverse axis.

16. The heat exchanger assembly according to claim 13, wherein at least one exchanger tube of the plurality of exchanger tubes has a cross-section which changes along its length.

17. The heat exchanger assembly according to claim 13, wherein the first pair of adjacent exchanger tubes extends along a longitudinal axis a greater distance than the second pair of adjacent exchanger tubes, the longitudinal axis being perpendicular to the transverse axis.

18. The heat exchanger assembly according to claim 13, wherein at least one exchanger tube of the plurality of exchanger tubes has first fluid-turbulence elements and second fluid-turbulence elements disposed therein, and wherein an arrangement of the first fluid-turbulence elements is different than an arrangement of the second fluid-turbulence elements.

19. The heat exchanger assembly according to claim 18, wherein the arrangement of the first fluid-turbulence elements comprises spacing between adjacent first fluid-turbulence elements and the arrangement of the second fluid-turbulence elements comprises spacing between adjacent second fluid-turbulence elements, and wherein the spacing between the adjacent second fluid-turbulence elements is greater than the spacing between the adjacent first fluid-turbulence elements.

20. A heat exchanger assembly for a motor vehicle, the heat exchanger assembly comprising:
an inlet tank;
an outlet tank;
a plurality of exchanger tubes of an exchanger core fluidly connecting the inlet tank and the outlet tank and extending along a transverse axis that extends perpendicular to a longitudinal axis of the motor vehicle, each exchanger tube of the plurality of exchanger tubes defines a fluid passage path for fluid, a first pair of adjacent exchanger tubes form a first air passage path therebetween for ambient air and a second pair of adjacent exchanger tubes form a second air passage path therebetween for the ambient air;
first air-turbulence elements extending vertically and located between the first pair of adjacent exchanger tubes in the first air passage path; and
second air-turbulence elements extending vertically and located between the second pair of adjacent exchanger tubes in the second air passage path,
wherein spacing between the second air-turbulence elements is greater than spacing between the first air-turbulence elements such that the first air-turbulence elements deflect a portion of the ambient air flowing therethrough toward the second air passage path,
wherein the first pair of adjacent exchanger tubes extends along the longitudinal axis a greater distance than the second pair of adjacent exchanger tubes, and
wherein at least one exchanger tube of the plurality of exchanger tubes has first fluid-turbulence elements and second fluid-turbulence elements disposed therein, and wherein spacing between the first fluid-turbulence elements is different than spacing between the second fluid-turbulence elements.
